(19) United States
(12) Patent Application Publication
(10) Pub. No.: US 2005/0193630 A1
(43) Pub. Date: Sep. 8, 2005

(54) Hardware for window sashes

(76) Inventors: Gary Marshik, Canton, SD (US); Scott Meunier, Sioux Falls, SD (US); Stephen M. Piltingsrud, Sioux Falls, SD (US); James Ripley, Canton, SD (US)

Correspondence Address: TESTA, HURWITZ & THIBEAULT, LLP, HIGH STREET TOWER, 125 HIGH STREET, BOSTON, MA, 02110, US

(21) Appl. No.: 10/795,958

(22) Filed: Mar. 8, 2004

(51) Int. Cl. E05D 15/22

(52) U.S. Cl. 49/181

(57) ABSTRACT

The invention relates to hardware for use with a tilt-out type window sash. The hardware includes a pivot bar that is adapted to be received in a first aperture formed in a window sash and a tilt latch that is adapted to be received in a second aperture formed in a window sash, where the first aperture and the second aperture have substantially common profiles, such that the pivot bar and the tilt latch are interchangeably locatable in the profiles.

### TECHNICAL FIELD

The invention relates generally to tilt-out windows and associated tilt latch and pivot bar hardware located within apertures formed in a window sash.

### BACKGROUND OF THE INVENTION

Tilt-out windows typically appear in a double hung version with a lower sash and an upper sash. The two sashes are mounted on slide blocks which, in turn, are slideably mounted on opposed, vertically extending jamb channels located in a window frame. Each sash includes a top rail, a bottom rail, and a pair of stiles connected together at adjacent extremities to form a substantially rectangular sash frame that holds the window glazing.

Often, a pair of tilt latches are disposed on opposite ends of the top rail of the sash frame. The tilt latches are used to maintain the sash in a vertical position within the frame or to allow the sash to be tilted into a room for cleaning when the tilt latches are released. Typically, the tilt latches are used in combination with a pair of pivot bars that are generally located on opposite sides of the window sash at the bottom rail. The pivot bars are used in conjunction with the slide blocks that are slideably mounted in each jamb channel. A connecting pin portion of each pivot bar extends into an opening in a locking cam member housed within each slide block. Together, the pivot bars and the slide blocks provide pivot points for the sash to be tilted into a room to be cleaned. To maintain the vertical position of the window sash in the jamb channel when the window sash is raised, a spring balance mechanism that counteracts the weight of the sash is attached to each block.

One method of coupling the pivot bars and the tilt latches to the sash is to have the tilt latches and pivot bars received in apertures that are routed or formed in the window sash. One problem associated with this coupling method is the relatively complicated and time consuming manufacturing process required to route apertures in the sash that have different profiles to accommodate pivot bars and tilt latches that are sized and shaped differently.

### SUMMARY OF THE INVENTION

In general, the invention relates to a hardware combination for use with a tilt-out type window sash. The hardware combination reduces the time required to manufacture tilt-out type windows, while simultaneously reducing manufacturing costs by simplifying the manufacturing process. More specifically, the invention reduces the number of differing aperture profiles that need to be routed into the window sash to accommodate the tilt latches and pivot bars.

In one aspect, the hardware combination includes a pivot bar adapted to be received in a first aperture formed in a window sash and a tilt latch adapted to be received in a second aperture formed in a window sash. The first aperture and the second aperture have substantially common profiles, such that the pivot bar and the tilt latch are interchangeably locatable in the first aperture and the second aperture.

In one embodiment, the tilt latch includes a body and a retractable member for selectively engaging a jamb channel when the body is received in a window sash aperture. The member can be biased in an extended position from the body to engage the jamb channel. The tilt latch can further include a release for retracting and disengaging the member from the jamb channel. The tilt latch can also include a tab for retaining the body in a window sash when received in a window sash aperture.

In additional embodiments, the pivot bar and the tilt latch each include a top surface for engaging a respective portion of a profile of the aperture formed in the window sash, the top surface of the pivot bar and the top surface of the tilt latch having substantially common mating perimeters. The pivot bar and the tilt latch can also include a front surface for engaging a respective portion of a profile of the aperture formed in the window sash, the front surface of the pivot bar and the front surface of the tilt latch having substantially common mating perimeters.

In another aspect, the invention relates to a sash for a tilt-out type window assembly. The sash includes a first sash portion forming a first aperture for receiving a tilt latch, and a second sash portion forming a second aperture for receiving a pivot bar. The first aperture and the second aperture include substantially common profiles, such that the pivot bar and the tilt latch are interchangeably locatable therein.

In various embodiments, the sash further includes a third sash portion forming a third aperture for receiving a second pivot bar, where the profile of the third aperture is substantially common to the profile of the second aperture. The sash can also include a sash portion forming a fourth aperture for receiving a second tilt latch, where the profile of the fourth aperture is substantially common to the profile of the first aperture. In other embodiments, the first sash portion includes a top rail and the second sash portion includes a bottom rail. The first sash portion and the second sash portion can also include a stile.

In another aspect, the invention relates to a method of manufacturing a window sash. The method includes the steps of forming a first aperture in a first portion of the window sash and forming a second aperture in a second portion of the window sash, where the first aperture and the second aperture include substantially common profiles and each profile is adapted to receive interchangeably one of a pivot bar and a tilt latch.

In various embodiments, the method includes forming the first aperture and the second aperture in a machining operation. The first aperture and the second aperture can also be formed using a common cutting tool. The method can also include the step of forming a third aperture in a third portion of the window sash, where the first aperture and the third aperture include substantially common profiles and each profile is adapted to receive interchangeably one of the pivot bar and the tilt latch. In a further embodiment, the method can include the step of forming a fourth aperture in a fourth portion of the window sash, where the second aperture and the fourth aperture include substantially common profiles and each profile is adapted to receive interchangeably one of the pivot bar and the tilt latch.

In another aspect, the invention relates to a pivot bar for use in a tilt-out window assembly. The pivot bar includes an elongate body defining a groove at least partially circumscribing the body and a pivot element extending from the body. In one embodiment, the elongate body is substantially planer. The pivot element can be adapted to selectively engage a balance shoe. In additional embodiments, the pivot element is integral with the body and can be substantially T-shaped.

In further embodiments, the pivot bar can include a tab for retaining the body in a window sash when the body is installed in the window sash. In another embodiment, the groove is adapted to operatively engage a profile of an aperture in a sash. The pivot bar can also include a shoulder from which the pivot element extends, the shoulder including an increased thickness relative to the substantially planar elongate body.

These and other objects, along with advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis generally being placed upon illustrating the principles of the invention. In the following description, various embodiments of the present invention are described with reference to the following drawings, in which:

FIG. 1 is a perspective view of a tilt-out window in accordance with one embodiment of the invention;

FIG. 2 is a schematic perspective view of a tilt latch and a sash profile in accordance with one embodiment of the invention;

FIG. 3 is a schematic perspective view of a pivot bar and an inverted sash profile in accordance with one embodiment of the invention; and

FIG. 4 is a schematic alternative perspective view of the pivot bar of FIG. 3.

### DETAILED DESCRIPTION

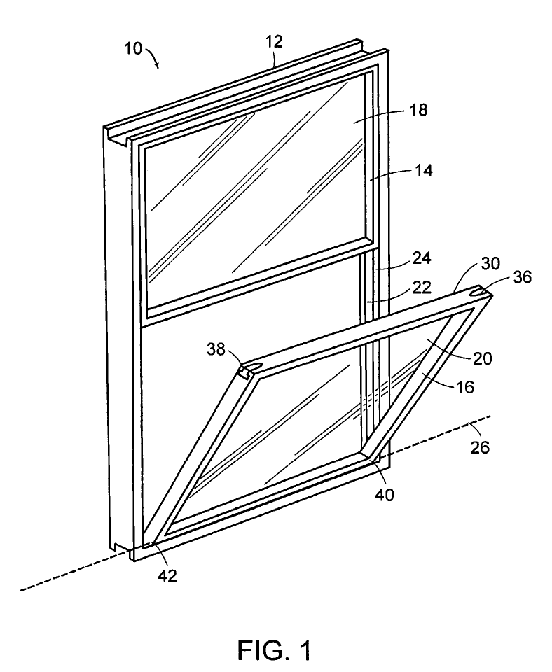

FIG. 1 shows one embodiment of a double-hung tilt-out window assembly 10. The window assembly 10 includes a frame 12, an upper sash 14, and a lower sash 16, the upper and lower sashes 14, 16 each supporting windowpanes 18, 20 respectively. The frame 12 also has four jamb channels 22, one of which is shown in FIG. 1, formed in respective jambs 24 of the frame 12. One jamb channel 22 is proximate each side of each of the upper sash 14 and the lower sash 16. As shown in FIG. 1, the lower sash 16 is partially tilted about a horizontal axis 26 that extends through a pair of pivot bars, so that both sides of the windowpane 20 within the lower sash 16 are accessible for cleaning from the same side of the window assembly 10. For simplicity, the remainder of the description will focus on the lower sash 16; however, it should be understood that the features attributable to the lower sash 16 may also be incorporated into the upper sash 14 in various embodiments.

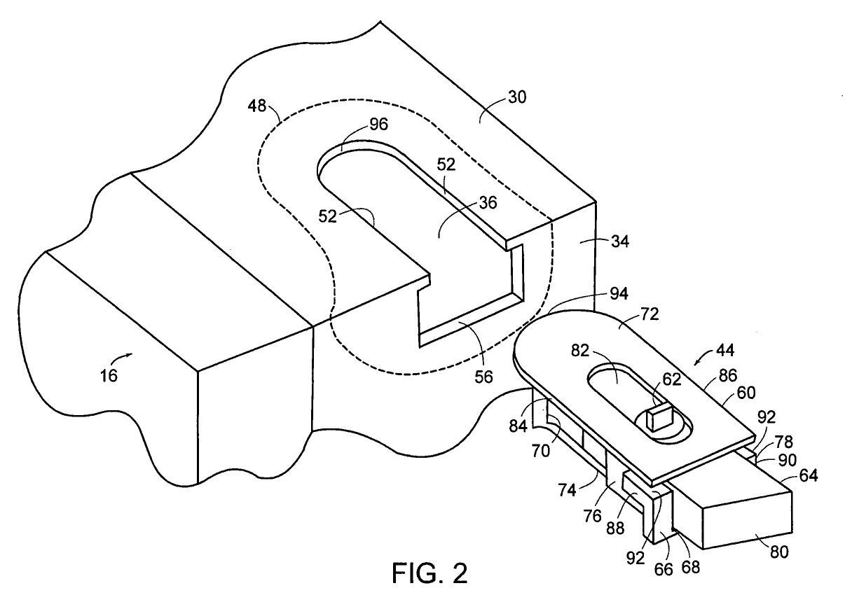

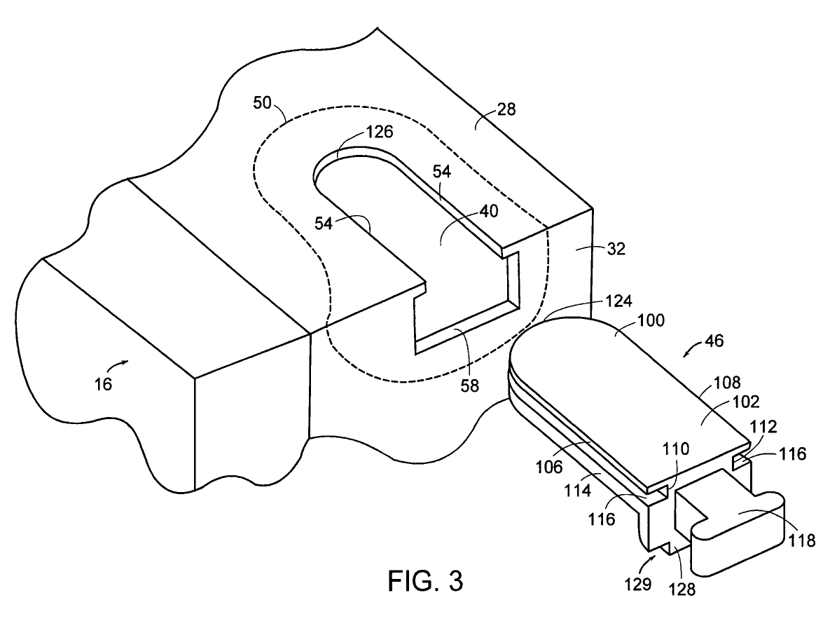

With reference to FIGS. 2 and 3, in one embodiment, the sash 16 can be manufactured from corner welded extrusions. The sash 16 includes a hollow top sash rail 28, a hollow bottom sash rail 30, and a pair of hollow stiles 32, 34 cooperatively connected together at adjacent extremities thereof to form a rectangular sash frame that encloses the windowpane 20. The sash 16 may be made from materials including but not limited to plastics, metals, woods and combinations thereof and may be created in various embodiments through an extrusion process, an injection molding process or through machining. In a particular embodiment, the sashes are made from a polymer, such as extruded vinyl.

The top sash rail 28 and the bottom sash rail 30 each include a pair of opposing apertures 36, 38, 40, 42 formed therein. In each of FIGS. 2 and 3, only one aperture 36, 40 is shown of the pair. The opposing apertures 38, 42 are substantially identical. The apertures 36, 38, 40, 42 may be formed by routing the hollow top sash rail 28 and the hollow bottom sash rail 30 in a machining operation. Alternatively, the apertures may be created by pre-punching the hollow sash rails 28, 30. In yet another embodiment, the sashes may be solid, in which case the sashes may be plunge routed to form the apertures using, for example, a suitably shaped router bit or milling cutter.

As shown in FIGS. 2 and 3, the first aperture 36 that receives a tilt latch 44 and the second aperture 40 that receives a pivot bar 46 have substantially common profiles. The substantially common profiles of the first aperture 36 and the second aperture 40 enable the tilt latch 44 to be interchangeably received in either the first aperture 36 or the second aperture 40. Similarly, the pivot bar 46 can also be interchangeably received in either the first aperture 36 or the second aperture 40. Additionally, the tilt latch 44 and the pivot bar 46 can be interchangeably received in the third and fourth apertures 38, 42. The first aperture 36, as illustrated in FIG. 2, is formed in a first portion 48 of the window sash 16. In sashes constructed with corner miter joints, the first portion 48 includes a portion of the stile 34 and a portion of the top sash rail 30. In other embodiments, however, the first aperture 36 may be formed exclusively in the stile 34 or exclusively in the top sash rail 30. Similarly, the second aperture 40, as illustrated in FIG. 3, is formed in a second portion 50 of the window sash 16. The second portion 50 includes a portion of the stile 32 and a portion of the bottom sash rail 28. In other embodiments, the second aperture 40 may be formed exclusively in the stile 32 or exclusively in the bottom sash rail 28.

The profiles of the first aperture 36 and the second aperture 40 are substantially common. The profile of the first aperture 36 includes a pair of longitudinally extending guide rails 52 as does the profile of the second aperture 40. The guide rails 52 in the first aperture 36 and the guide rails 54 in the second aperture 40 are adapted to mate with a mating hardware perimeter, such as longitudinally extending grooves (described below) that are formed on external surfaces of both the tilt latch 44 and the pivot bar 46. The profile of the first aperture 36 and the profile of the second aperture 40 also include lips 56, 58 that are formed in the stiles 32, 34. The lips 56, 58 are vertically spaced from the top sash rail 30 and the bottom sash rail 28 respectively. The lips 56, 58 act to support and orient the tilt latch 44 or the pivot bar 46 when either piece of hardware is disposed within the first aperture 36 or the second aperture 40.

In various embodiments, the profiles of the first aperture 36 and the second aperture 40 need not be identical, and may slightly differ from each other; however, the profiles remain substantially common, insofar as the tilt latch 44 and the pivot bar 46 can be interchangeably received in the first aperture 36 and the second aperture 40. For instance, the first aperture 36 and the second aperture 40 may further include one or more grooves or rails formed in the sash 16 to further support the tilt latch 44 or the pivot bar 46. Alternatively, the profile of the first aperture 36 and the profile of the second aperture 40 may be routed to correspond with a different tilt latch 44 and a pivot bar 46 combination than that illustrated in FIGS. 2-3. In other embodiments, the first aperture 36 or the second aperture 40 can be formed to include ornamental designs that do not impact the interchangeability of the tilt latch 44 and the pivot bar 46. In yet another embodiment, the first aperture 36 and the second aperture 40 may differ slightly in their profiles, without impacting the interchangeability of the tilt latch 44 and the pivot bar 46, to accommodate, for instance, tools to remove the tilt latch 44 or the pivot bar 46 once they have been installed in the sash 16. In general, the first aperture 36 and the second aperture 40 can have any profile desired, so long as the profiles remain substantially common so that the tilt latch 44 and the pivot bar 46 are interchangeably locatable therein.

In another embodiment, a third sash portion forming the third aperture 42 for receiving a second pivot bar 46 can be included in the sash 16. The profile of the third aperture 42 is substantially common to the profile of the second aperture 40. Similarly, a fourth sash portion forming the fourth aperture 38 for receiving a second tilt latch 44, where the profile of the fourth aperture 38 is substantially common to the profile of the first aperture 36, can also be included in the sash 16. The fourth sash portion, in one embodiment, includes the top sash rail 30 and a stile 32. In other embodiments, however, the fourth sash portion may include only the stile 32 or the top sash rail 30. The third sash portion, in one embodiment, includes the bottom sash rail 28 and the stile 34. In other embodiments, however, the third sash portion may include only the stile 34 or the bottom sash rail 28. The third sash aperture 42 and the fourth sash aperture 38 can include any of the features or configurations described above with respect to the first aperture 36 and the second aperture 40.

With reference to FIG. 2, the tilt latch 44 in accordance with one embodiment of the present invention is illustrated. The tilt latch 44 is adapted to be interchangeably received in all of the apertures 36, 38, 40, 42 previously described. The tilt latch 44 includes a body 60, a release 62, and a retractable member 64. In a particular embodiment, the release 62 and the body 60 are made from Zamak 3 and the retractable member 64 is made from a glass filled nylon. It will however be appreciated that the body 60, the release 62, and the retractable member 64 can be made from any suitable material, including plastics, woods, metals, and combinations thereof.

The body 60 has a front surface 66 defining an opening 68. The body 60 also includes an inner chamber 70 that is in communication with the opening 68. The inner chamber 70 is defined by a top surface 72, a bottom surface 74, and a pair of spaced substantially parallel side 76, 78 walls that extend from the top surface 72 to the bottom surface 74. It will be appreciated that the scope of the invention includes modifications to the body 60. For instance, the bottom surface 74 of the body 60 can be absent and tabs can be used to form the chamber 70. Moreover, the body 60 could be formed from a single piece of material or from several pieces. When the tilt latch 44 is assembled and received in an aperture, the retractable member 64 is biased in a position extending outwardly through the opening 68 of the body 60 by a biasing member, such as a compression spring (not shown). In the extended position, the retractable member 64 engages the jamb channel 22 to prevent the sash 16 from tilting inadvertently out of the window frame 12. The retractable member 64 typically has an angled edge 80 to facilitate returning a tilted sash to an engaged, vertical orientation. The release 62, which is disposed on a top surface 82 of the retractable member 64 enables the retractable member 64 to be retracted and disengaged from the jamb channel 22 when the release 62 is actuated to counteract the biasing force applied by the biasing member. In another embodiment, the release 62 may be formed integrally with the retractable member 64.

With continuing reference to FIG. 2, the top surface 72 of the body 60 has opposing longitudinal edges 84, 86 that may be spaced outwardly from the side walls 76, 78. The side walls 76, 78 extend downwardly from the top surface 72 of the body 60. Protrusions 88, 90 extend outwardly from the side walls 76, 78 approximately the same distance as the longitudinal edges 84, 86 of the top 72. A groove 92 is formed between the longitudinal edges 84, 86 of the top surface 72 and the protrusions 88, 90 that extend from the side walls 76, 78 thereby forming one possible mating perimeter. When the tilt latch 44 is mounted in an aperture 36, 38, the groove 92 receives the opposing guide rails 52 of the top sash rail 30. In another embodiment, a protrusion, similar to the protrusions 88, 90 may be included at a back portion 94 of the tilt latch 44. The protrusion and the top 72 form a groove that receives a curved portion 96 of the guide rail 52 when the tilt latch 44 is mounted in an aperture 36, 38.

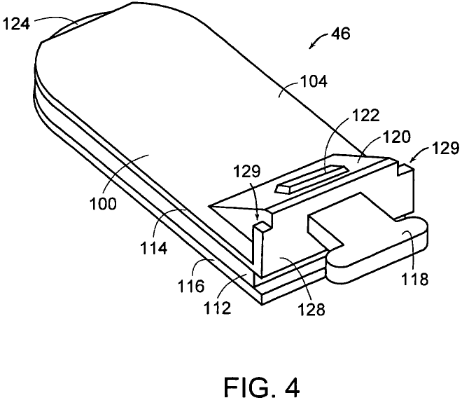

Disposed proximate the front surface 66 and extending from the bottom surface 74 of the tilt latch 44 is a tab (See, for example, tab 122 in FIG. 4) for engaging the lip 56 of the stile 34 of the sash 16. The tab may be formed integrally with the bottom surface 74 of the body 60, but could also be a separate piece.

In use, the tilt latch 44 is inserted into the first aperture 36 formed in the sash 16. The tilt latch 44 is inserted such that the grooves 92 formed in the body 60 of the tilt latch 44 receive the guide rails 52 of the top sash rail 30. The tilt latch 44 is inserted into the first aperture 36 until the back portion 94 of the tilt latch 44 abuts the curved portion 96 of the first aperture 36 and the tab engages the lip 56 of the stile 34. The latch 44 can then be gently tapped on its top surface 72 and/or on its front surface 66 using a rubber hammer to seat the latch 44 and, optionally, embed the tab into the stile 34, if necessary. As described, the latch 44 may be secured into the sash 16 without the use of a fastener, such as a screw. However, in other embodiments, an additional fastener may be utilized to further secure the latch 44 in the sash 16.

It will be appreciated that different configurations for the body 60 exist that may be used in accordance with the invention. For instance, U.S. Pat. No. 6,485,070 to Shultz, the disclosure of which is hereby incorporated by reference herein in its entirety, discloses different permutations of a latch body that may be used in accordance with the teachings of the invention. In general, any configuration of the tilt latch 44 is permissible, so long as the tilt latch 44 is interchangeably locatable in the apertures 36, 38, 40, 42 in the sash 16 adapted also to receive pivot bars 46, as earlier described.

With reference to FIGS. 3 and 4, the pivot bar 46 in accordance with one embodiment of the present invention is illustrated. The pivot bar 46 includes an elongate body 100 made from a material such as Zamak 3, the body 100 having a top surface 102 and a bottom surface 104. The top surface 102 includes a pair of longitudinally extending edges 106, 108 that may be spaced outwardly from a pair of side walls 110, 112 that extend vertically downward from the top surface 102. Each side wall 110, 112 in turn has a rail 114 that extends outwardly from the side wall 110, 112 approximately the same distance as the longitudinal edges 106, 108 of the top surface 102. A groove 116 is formed between the longitudinal edges 106, 108 of the top surface 102 and the rails 114 that extend from the side walls 110, 112 thereby forming one example of a mating perimeter. In the embodiment shown, the elongate body 100 is substantially planar.

Extending from a front surface 128 of the body 100 is a pivot element 118. The pivot element 118 can be adapted to selectively engage a balance shoe (not shown). The pivot element 118 may be formed integrally with the body 100 of the pivot bar 46 in a casting process, but may also be a separate piece that is affixed to the body 100 by any technique desirable, such as threading or gluing. In the illustrated embodiment, the pivot element 118 is substantially T-shaped, but the pivot element 118 may be any other shape as necessary to engage the balance shoe.

Disposed on the bottom surface 104 of the pivot bar 46 is a shoulder 120 that includes the tab 122 for engaging the lip 58 of the stile 32 when the pivot bar 46 is installed in the sash 16. The shoulder 120 has increased thickness relative to the substantially planar elongate body 100 and therefore acts as a gusset to enable the pivot element 118 to bear the weight of the sash 16 when the pivot bar 46 is received in the aperture 40 and the sash 16 is operatively connected to the balance shoes. The tab 122, the shoulder 120, and the body 100 may be formed integrally in a casting process, but they could also be separate pieces.

In use, the pivot bar 46 is inserted into the second aperture 40 formed in the sash. The pivot bar 46 is inserted such that the groove 116 formed in the body 100 of the pivot bar 46 receives the guide rails 54 of the bottom sash rail 28. The pivot bar 46 is inserted until a back portion 124 of the pivot bar 46 abuts a curved portion 126 of the second aperture 40 and the tab 122 engages the lip 58 of the stile 32. The pivot bar 46 can then be gently tapped on its top surface 102 and/or its front surface 128 using a rubber hammer to seat the pivot bar 46 and, optionally, embed the tab 122 into the stile 32, if necessary. As described, the pivot bar 46 may be secured into the sash 16 without the use of a fastener, such as a screw. However, in other embodiments, an additional fastener may be utilized to further secure the pivot bar 46 in the sash 16.

In accordance with the invention, the pivot bar 46 can have many different configurations. For instance, the rails 114 that extend around the circumference of the pivot bar 46 could be non-continuous and include any number of spaced projections to form a non-continuous groove with the top surface 102. Alternatively, the rails 114 could be fully continuous. The longitudinal edges 106, 108 on the top surface 102 could also be non-continuous. The rail 114 could also consist of one or several projections adjacent a front surface 128 of the body 100 and a projection at the back portion 124 of the body to form the groove 116 with the top surface 102. In general, the pivot bar 46 can have any desired feature or geometry so long as the pivot bar 46 and the tilt latch 44 are interchangeably locatable in the first aperture 36 and the second aperture 40 formed in the window sash 16.

With further reference to FIGS. 2 and 3, the tilt latch 44 and the pivot bar 46 each include top surfaces 72, 102 for engaging a respective portion of a profile of an aperture formed in the window sash 16. In the illustrated embodiment, the top surface 72 of the tilt latch 44 and the top surface 102 of the pivot bar 46 have substantially common mating perimeters (for example, the grooves 92, 116 and rails 84, 86, 88, 90, 106, 108, 114 that circumscribe the tilt latch 44 and pivot bar 46) are substantially common, such that the tilt latch 44 and pivot 46 can be inserted into any commonly routed aperture 36, 38. In other embodiments, however, the top surface 72 of the tilt latch 44 and the top surface 102 of the pivot bar 46 need not be identical and may have differing mating perimeters, as long as they are physically interchangeably receivable in a common aperture.

Also, in the illustrated embodiment, the tilt latch 44 and the pivot bar 46 each include a front surface 66, 128 for engaging a respective portion of a profile of an aperture formed in the window sash 16, where the front surface 66 of the tilt latch 44 and the front surface 128 of the pivot bar 46 also have substantially common mating perimeters. In the illustrated embodiment, the mating perimeters of the front surfaces 66, 128 are substantially rectangular, so that both the tilt latch 44 and the pivot bar 46 may be received in, and mate with, the aperture profiles 36, 40 formed in the sash 16. However, as can seen in FIGS. 2 and 3, the front surfaces 66, 128 of the tilt latch 44 and pivot bar 46 are not identical, since the front surface 128 of the pivot bar 46, in contrast to the front surface 66 of the tilt latch 44, includes notches 129 that may be used with a tool to pry the pivot bar 46 from the sash 16 when the pivot bar 46 is installed therein. In other embodiments, the mating perimeters of the front surfaces 66, 128 could be any other shape required to mate with the aperture profiles 36, 40 formed in the sash 16. However, even with differing front surface 66, 128 perimeters, the tilt latch 44 and the pivot bar 46 are interchangeably locatable in the first aperture 36 and the second aperture 40 formed in the window sash 16, the first aperture 36 and the second aperture 40 having substantially common profiles.

The hardware combination of the present invention is advantageous since it simplifies the manufacturing process associated with routing apertures in window sashes. For instance, a common cutting tool can be used to form the apertures. Depending on the manufacturing setup, fewer cutting tools may be required since the same tool can be used to route each aperture, or a plurality of common cutting tools can be used to route all apertures simultaneously.

Other embodiments incorporating the concepts disclosed herein may be used without departing from the spirit and scope of the invention. The described embodiments are to be considered in all respects as only illustrative and not restrictive.

1. A hardware combination for use with a tilt-out type window sash, comprising:
a pivot bar adapted to be received in a first aperture formed in a window sash; and
a tilt latch adapted to be received in a second aperture formed in a window sash, wherein the first aperture and the second aperture have substantially common profiles, such that the pivot bar and the tilt latch are interchangeably locatable therein.

2. The hardware combination of claim 1, wherein the tilt latch comprises a body and a retractable member for selectively engaging a jamb channel when the body is received in a window sash aperture.

3. The hardware combination of claim 2, wherein the member is biased in an extended position from the body to engage the jamb channel.

4. The hardware combination of claim 3, wherein the tilt latch further comprises a release for retracting and disengaging the member from the jamb channel.

5. The hardware combination of claim 1, wherein the tilt latch further comprises a tab for retaining the body in a window sash when received in a window sash aperture.

6. The hardware combination of claim 1, wherein the pivot bar and the tilt latch each comprise a top surface for engaging a respective portion of a profile of the aperture formed in the window sash, the top surface of the pivot bar and the top surface of the tilt latch having substantially common mating perimeters.

7. The hardware combination of claim 1, wherein the pivot bar and the tilt latch each comprise a front surface for engaging a respective portion of a profile of the aperture formed in the window sash, the front surface of the pivot bar and the front surface of the tilt latch having substantially common mating perimeters.

8. A sash for a tilt-out type window assembly, comprising:
a first sash portion forming a first aperture for receiving a tilt latch; and
a second sash portion forming a second aperture for receiving a pivot bar, wherein the first aperture and the second aperture comprise substantially common profiles, such that the pivot bar and the tilt latch are interchangeably locatable therein.

9. The sash of claim 8, further comprising a third sash portion forming a third aperture for receiving a second pivot bar, wherein the profile of the third aperture is substantially common to the profile of the second aperture.

10. The sash of claim 9, further comprising a fourth sash portion forming a fourth aperture for receiving a second tilt latch, wherein the profile of the fourth aperture is substantially common to the profile of the first aperture.

11. The sash of claim 8, wherein the first sash portion comprises a top rail.

12. The sash of claim 8, wherein the second sash portion comprises a bottom rail.

13. The sash of claim 11, wherein the first sash portion further comprises a stile.

14. The sash of claim 12, wherein the second sash portion further comprises a stile.

15. A method of manufacturing a window sash comprising the steps of:
forming a first aperture in a first portion of the window sash; and
forming a second aperture in a second portion of the window sash, wherein the first aperture and the second aperture comprise substantially common profiles and each profile is adapted to receive interchangeably one of a pivot bar and a tilt latch.

16. The method of claim 15, wherein the first aperture and the second aperture are formed in a machining operation.

17. The method of claim 15, wherein the first aperture and the second aperture are formed using a common cutting tool.

18. The method of claim 15, further comprising the step of forming a third aperture in a third portion of the window sash, wherein the first aperture and the third aperture comprise substantially common profiles and each profile is adapted to receive interchangeably one of the pivot bar and the tilt latch.

19. The method of claim 18, further comprising the step of forming a fourth aperture in a fourth portion of the window sash, wherein the second aperture and the fourth aperture comprise substantially common profiles and each profile is adapted to receive interchangeably one of the pivot bar and the tilt latch.

20. A pivot bar for use in a tilt-out window assembly, the pivot bar comprising:
an elongate body defining a groove at least partially circumscribing the body; and
a pivot element extending from the body.

21. The pivot bar of claim 20, wherein the elongate body is substantially planar.

22. The pivot bar of claim 20, wherein the pivot element is adapted to selectively engage a balance shoe.

23. The pivot bar of claim 20, wherein the pivot element is integral with the body.

24. The pivot bar of claim 20, wherein the pivot element is substantially T-shaped.

25. The pivot bar of claim 20, further comprising a tab for retaining the body in a window sash when installed therein.

26. The pivot bar of claim 20, wherein the groove is adapted to operatively engage a profile of an aperture in a sash.

27. The pivot bar of claim 21, wherein the pivot bar further comprises a shoulder from which the pivot element extends, the shoulder comprising an increased thickness relative to the substantially planar elongate body.
